(19) United States
(12) Patent Application Publication
(10) Pub. No.: US 2008/0186438 A1
(43) Pub. Date: Aug. 7, 2008

(54) METHOD AND APPARATUS FOR ALIGNMENT FILM, ALIGNMENT FILM, AND LIQUID CRYSTAL DEVICE

(75) Inventors: Akira Sakai, Kawasaki-shi (JP); Toshiaki Aiba, Fujisawa-shi (JP); Yohei Ishida, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/026,085

(22) Filed: Feb. 5, 2008

(30) Foreign Application Priority Data
Feb. 7, 2007 (JP) 2007-028040
Jan. 31, 2008 (JP) 2008-021010

(51) Int. Cl. G02F 1/1337; G02F 1/13

(52) U.S. Cl. 349/125; 349/187

(57) ABSTRACT

A first film is formed on a substrate by oblique deposition and thereafter a second film is formed on the first film by sputtering.

### FIELD OF THE INVENTION AND RELATED ART

The present invention relates to a film forming method and apparatus for a liquid crystal alignment film used in a reflection-type or transmission-type liquid crystal display apparatus and the like. The present invention also relates to a liquid crystal alignment film and a liquid crystal device.

An alignment film used in a liquid crystal device includes an organic alignment film such as a polyimide film, a polyamide film, or the like and an inorganic alignment film such as an SiOx film, or the like. The inorganic alignment film is used for a homeotropic alignment liquid crystal. An SiO₂ oblique deposition film as an example of the inorganic alignment film is obtained by vaporizing SiO₂ particles by an electron beam deposition apparatus to be deposited on a TFT substrate or an opposing substrate at a desired angle.

Most of the oblique deposition films have a groove structure or a column structure and change their shapes depending on an angle formed between an incident direction of deposition particles and a normal to a substrate, i.e., a deposition angle. Depending on the change in shape, an alignment direction of a liquid crystal is changed.

At a deposition angle of 20 deg. (degrees) or more, an in-plane alignment direction of the liquid crystal is not determined, thus resulting in random alignment. At a deposition angle of about 50 deg., horizontal alignment with an inclination angle of 0 deg. appears by a groove structure in which proves are perpendicular to an incident surface of a deposit at a substrate surface. Further, at a deposition angle of 80 deg. or more, a column-like anisotropic structure is developed, so that liquid crystal molecules are aligned with an inclination with respect to the substrate normal in a plane which is perpendicular to the substrate and includes a deposition beam. An angle of the inclination can be controlled in a certain range by finely adjusting the deposition angle at 80 deg. or more.

When the alignment film is formed by the oblique deposition, it is necessary to effect deposition by strictly adjusting the deposition angle. However, a deposition source is a point source, so that the deposition angle varies depending on a position of a substrate surface. For this reason, in order to uniformly form a film on a large-area substrate, a distance between the substrate and the deposition (evaporation) source is required to be large, so that a ratio of an amount of a deposit reaching the substrate to an amount of vaporization at the deposition source is decreased. As a result, it has been difficult to increase a film forming speed.

### SUMMARY OF THE INVENTION

A principal object of the present invention is to provide a film forming method and a film forming apparatus which are capable of increasing a film forming speed.

Another object of the present invention is to provide an alignment film capable of fine alignment control of a pretilt angle of a liquid crystal device.

A further object of the present invention is to provide a liquid crystal device capable of providing a thick column, a high filling ratio, a stabilized pretilt angle, and a high durability performance.

According to an aspect of the present invention, there is provided a method for forming an alignment film of a liquid crystal, comprising:

a step of forming a first film on a substrate by an oblique deposition method; and

a step of forming a second film on the first film by a sputtering method.

By forming the second film by the sputtering having a large film forming speed after forming the alignment film by the oblique deposition, it is possible to increase the film forming speed.

According to another aspect of the present invention, there is provided a film forming apparatus for forming an alignment film of a liquid crystal, comprising:

first means for evaporating a first material by heating a source of the first material;

second means for evaporating a second material by sputtering a target of the second material; and

a stage for mounting a substrate to obliquely deposit the first material evaporated by the first means and to deposit the second material evaporated by the second means onto the first material.

According to a further aspect of the present invention, there is provided an alignment film of a liquid crystal comprising:

a first film formed on a substrate by an oblique deposition method; and

a second film formed on said first film by a sputtering method.

According to a still further aspect of the present invention, there is provided a liquid crystal device comprising:

a pair of substrates;

an alignment film formed on an inner surface of each of said pair of substrates; and

a liquid crystal disposed between said pair of substrates,

wherein said alignment film comprises a first film formed by an oblique deposition method and a second film formed on the first film by a sputtering method.

According to the present invention, by forming the second film by the sputtering having a large film forming speed after forming the first film by the oblique deposition, the film forming speed can be increased.

Further, it is possible to not only realize fine alignment control of a pretilt angle of the liquid crystal device but also provide a liquid crystal device providing a thick column, a high filling ratio, a stabilized pretilt angle, and a high durability performance. In addition, it is possible to provide a bend mode liquid crystal device capable of transition from splay alignment to bend alignment at a low voltage, resulting in a large retardation.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIGS. 1(a), 1(b) and 1(c) are schematic views for illustrating an embodiment of the film forming method of the present invention.

FIG. 2 is a schematic view for illustrating an embodiment of the film forming apparatus of the present invention.

FIG. 3 is a schematic structural view of the liquid crystal device of the present invention.

FIGS. 4(a) to 4(d) are schematic views for illustrating liquid crystal alignment modes.

FIG. 5 is a graph showing a relationship between a deposition angle and a pretilt angle in the present invention.

FIG. 6 is a schematic view showing a distribution of a deposition angle at a deposition angle of 60 deg.

FIG. 7 is a schematic view showing a distribution of a deposition angle at a deposition angle of 80 deg.

FIGS. 8(a) and 8(b) are scanning electron microscope (SEM) images of liquid crystal alignment films in an embodiment of the present invention.

FIGS. 9(a) and 9(b) are schematic views showing liquid crystal alignment modes in Example 3 of the present invention.

FIGS. 10(a) and 10(b) are SEM images of liquid crystal alignment films in Example 3 of the present invention.

### DETAILED DESCRIPTION OF THE PREFERRED EMBODIMENTS

Hereinbelow, embodiments of the present invention will be specifically described with reference to the drawings.

### (Film Forming Method)

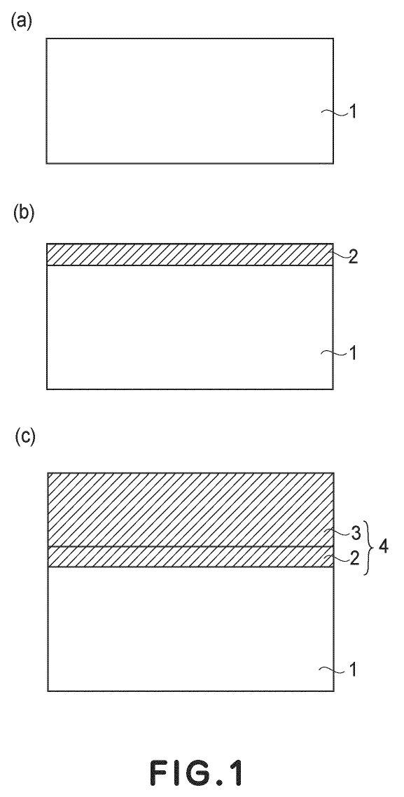

FIGS. 1(a), 1(b) and 1(c) are schematic views for illustrating a film forming method of an alignment film according to the present invention. Description will be made in the order of FIGS. 1(a), 1(b) and 1(c).

First, a substrate 1 is prepared as shown in FIG. 1(a).

The substrate 1 includes, in addition to a single substrate, an insulating substrate on which one or more layers of a conductive material or an insulating material are formed. In an actual device, a film of an electrode or the like is formed on the substrate by patterning in many cases.

As a material for the substrate 1, it is possible to use any material such as metal, semiconductor, glass, ceramics, organic materials, and the like. When a substrate of a light-transmissive material such as glass or plastic is used, the substrate is applicable to a device such as a liquid crystal display portion required to have light transmissivity.

As the substrate 1, a silicon wafer, quartz, glass, or these materials on which a thin film of polycrystalline silicon or amorphous silicon is formed may be used. It is also possible to use a metal plate, a ceramic plate, a film-like organic material, etc.

The substrate 1 may have any size but may preferably have a size of 8 inches or more. Also in the case where a substrate for a small-size liquid crystal device such as a liquid crystal shutter for a projector is manufactured, a substrate of 8 inches or more is subjected to film formation and thereafter is cut into small size.

A shape of the substrate 1 is ordinarily a smooth plate-like shape but is not limited thereto. For example, the substrate 1 may have a curved surface, a surface unevenness or stepped portion to some extent, or a combination thereof.

Next, as shown in FIG. 1(b), an alignment film (first film) 2 is formed on the substrate 1 by oblique deposition. The oblique deposition may include resistance heating deposition, electron beam deposition, laser ablation, and derivatives thereof.

Further, the film forming method is not particularly limited but may be a single method or a combination of plural methods so long as there is no inconvenience for alignment film formation and the like. However, in order to form a large-size film, the laser ablation is not desirable in some cases, whereas the resistance heating deposition, the electron beam deposition, and the derivatives thereof can be preferred.

A film forming temperature for the oblique deposition may be any temperature such as a room temperature or an elevated temperature. In the case of using a heat-labile material such as plastics or the like, it is preferable that the film formation is performed at temperatures near the room temperature.

The alignment film may preferably contain silicon (Si) and oxygen (O) as a main component (e.g., a silicon oxide content of 90 wt. % or more) in order to enhance transparency.

Further, the alignment film may have any crystallinity and may be amorphous, partially amorphous, crystalline, or the like.

A thickness of the alignment film is an important factor since it affects a liquid crystal alignment characteristic. When the thickness is large, it takes a long film forming time, so that throughput is undesirably decreased. In the present invention, in a subsequent step, film formation is performed at high speed by sputtering, so that the thickness of the alignment film in the oblique deposition step may be small.

Next, as shown in FIG. 1(c), an alignment film (second film) 3 is formed by sputtering on the alignment film (first film) disposed on the substrate 1. As a result, an (entire) alignment film 4 containing the first film 2 and the second film 3 is formed.

The sputtering may include RF sputtering, DC sputtering, a facing target method, ion-beam sputtering, and the like. Generally, a film forming speed of the sputtering is several times higher than that of the deposition methods. Typically, the film forming speed of the oblique deposition is about 0.1 nm/sec, whereas the film forming speed of the sputtering is 0.5-1.0 mm/sec. In the alignment film forming method of the present invention, a film formed by the oblique deposition and a film formed by the sputtering are laminated to have a predetermined film thickness as a whole. As a result, it is possible to form the alignment film having the predetermined film thickness in a shorter time than that in the case of forming an alignment film in the entire thickness by the oblique deposition, thus improving throughput.

The thickness of the sputtering film can be changed by adjusting a supply time of sputtering electric power. The thickness of the sputtering lamination film is set to provide an appropriate thickness in combination with the thickness of the oblique deposition film.

As a target material for the sputtering, SiO₂ is used.

The sputtering is performed, e.g., by introducing oxygen gas, it is possible to change a stoichiometric ratio of a column structure.

A film forming atmosphere for the sputtering may include any atmosphere including an atmosphere of rare gas such as Ar₂ or the like, an atmosphere of reaction gas such as O₂ or the like, an atmosphere of a mixture of these gases.

The sputtering is performed at temperature close to or higher than the room temperature. However, the film formation at temperatures close to the room temperature is preferable for the purpose of forming a film while keeping a groove structure or a column structure of the alignment film by decreasing a surface diffusion length of sputtering particles. Further, it is also preferable that the film formation at temperatures close to the room temperature in the case where a substrate containing a heat-labile material such as plastics or the like.

An elemental composition may be different between a lower layer (the second film 3) and an upper layer (the first film 2). A crystallinity may also be different between the lower layer and the upper layer. These characteristics are rather different ordinarily.

As described above, as to the thickness of the alignment film, from the viewpoint of improvement in throughput of the film formation, it is preferable that the lower layer has a smaller thickness than the upper layer.

### (Film Forming Apparatus)

After the oblique deposition film is formed, in the same vacuum apparatus, it is possible to laminate the sputtering film on the oblique deposition film. It is also possible to laminate the sputtering film on the oblique deposition film in another sputtering apparatus after the oblique deposition film is formed and the system is once opened to the air, but it takes a time to place the inside of the apparatus in a vacuum state, so that the film formation by the oblique deposition and the sputtering may preferably be successively performed in the same apparatus.

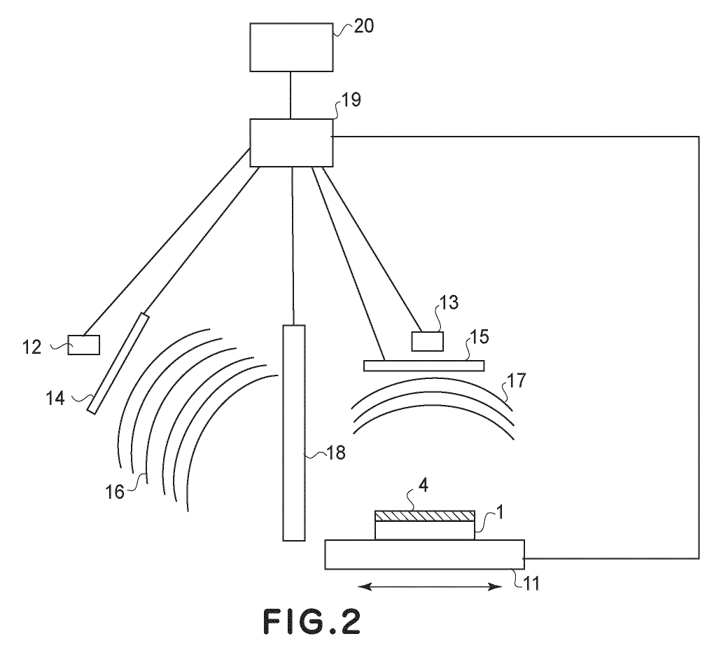

FIG. 2 is a film forming apparatus for performing successively the oblique deposition and the sputtering in the same vacuum apparatus. The substrate and the alignment film shown in FIG. 2 are represented by the same reference numerals as in FIG. 1.

The film forming apparatus includes a sample stage 11 for mounting thereon the substrate 1, an oblique deposition source 12, a sputtering target 13, an oblique deposition shutter 14, a sputtering shutter 15, oblique deposition particles 16, sputtering particles 17, a (movable) partition wall 18, a control system 19, and an operation system 20.

A distance from the oblique deposition source 12 to the center of the substrate 1 is 1 m. A larger distance from the oblique deposition source to the substrate provides a smaller deposition angle formed between an end portion of the substrate 1 and the oblique deposition source 12. A limit of a size of the vacuum apparatus is considered from the viewpoint of a mounting environment of a production facility and the like, so that the distance may appropriately be set.

A surface of the target 13 and the surface of the substrate 1 are ordinarily disposed in parallel with each other as shown in FIG. 2 but may also be inclined with respect to each other. It is also possible to rotate the substrate 1 so as to ensure uniform film formation.

The oblique deposition shutter 14 is used for opening and closing the oblique deposition particles 16 from the oblique deposition source 12 and is controlled by the control system 14 so that it is opened at the time of deposition start and is closed at the time of completion of the deposition. Particularly, the oblique deposition shutter 14 is controlled so that it is closed until the oblique deposition source 12 is stabilized and then is opened. The sputtering shutter 15 is also similarly controlled and thus opening and closing of the sputtering surface 15 are controlled by the control system 19.

The above-described constitutional members are disposed in a vacuum vessel (not shown) as desired and the inside of the vacuum vessel is evacuated to a vacuum by an evacuation system (not shown). Further, the control system 19 sends signals to and receives signals from the sample stage 11, the oblique deposition source 12, the sputtering target 13, the oblique deposition shutter 14, the sputtering shutter 15, the (movable) partition wall 18, a film formation control system (not shown), a vacuum control system (not shown), etc.

Particularly, the control system 19 effects control so that the second film 3 is formed on the first film 2 by the sputtering through the sputtering target 13 after the alignment film 2 is formed on the substrate 1 by the oblique deposition through the oblique deposition source 12. In this way, the control system 19 effects control, operation, and the like of the film forming apparatus through the operation system 20.

Further, on the basis of the control by the control system 19, the sample stage 11 is moved and rotated to mount the substrate 1 at an optimum position and direction for the film formation. By the control by the control system 19, a part or all of the (movable) partition wall 18 can be moved, thus being movable even to a retracted position (not shown). By the use of this (movable) partition wall 18, it is possible to facilitate control and the like of the sputtering atmosphere.

The sputtering gas is a rare gas such as Ar, Xe, Kr or the like, to which oxygen gas is added appropriately. A sputtering pressure is appropriately adjusted by a flow rate of an introduction gas and a degree of aperture of an exhaust conductance adjusting valve.

The film forming speed of the sputtering largely depends on a high-frequency electric power but it is possible to obtain a desired sputtering speed by appropriately adjusting the electric power. In the sputtering in the alignment film forming method of this embodiment, in order to alleviate ion bombardment, and reverse sputtering with respect to the substrate, the substrate may be placed in a ground state or a floating state or supplied with a bias.

A flux (deposit speed) of the deposit particles is lowered by increasing the deposition angle, so that there is apprehension that the deposit speed is substantially lowered. However, an insufficient flux (deposit speed) can be easily compensated for by an increase in electric power of an electron gun. An Si wafer substrate with a large set deposition angle can be disposed in a large number in a deposition space with a high filling efficiency, compared with the case of a small deposition angle.

In the film forming apparatus shown in FIG. 2, a step of forming the first film on the substrate by the oblique deposition and a step of forming the second film on the first film by the sputtering are successively performed in the same vacuum apparatus, so that a good-quality alignment film can be prepared at a high film forming speed.

### (Production Process of Liquid Crystal Cell)

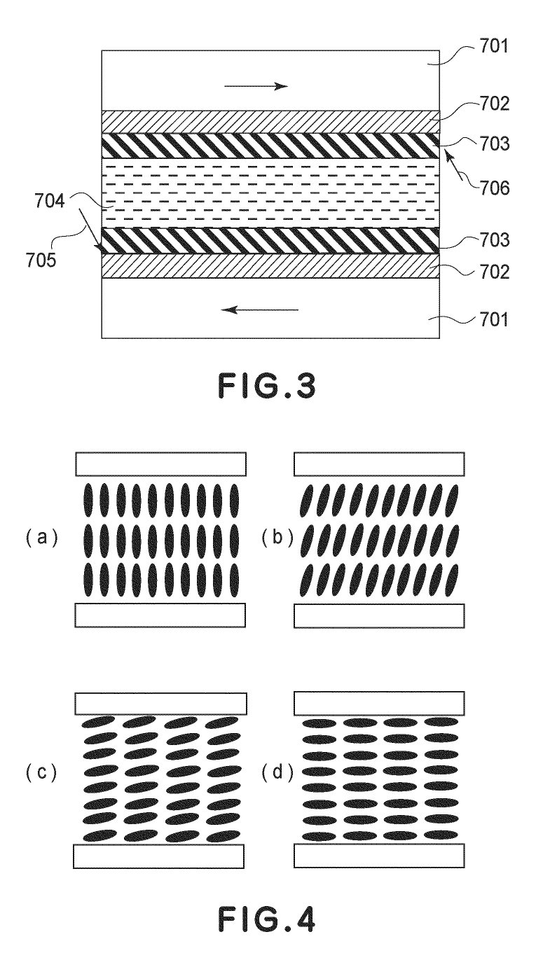

FIG. 3 is a schematic sectional view of the liquid crystal cell (liquid crystal device) prepared by using the alignment film formed according to the film forming method of the present invention. Referring to FIG. 3, the liquid crystal cell includes a pair of substrates (glass substrates) 701, ITO electrodes 702, alignment films 703, and a liquid crystal layer 704. The alignment films 703 are formed of a material comprising SiO₂ as a main component. The lower alignment film 703 is formed by the oblique deposition and the upper alignment film 703 is formed by the sputtering. Reference numerals 705 and 706 represent deposition directions, respectively.

The liquid crystal cell shown in FIG. 3 is prepared by applying the upper and lower substrates to each other so that the deposition directions are parallel and opposite to each other (i.e., anti-parallel). A spacing between the substrates is kept at a constant value by an unshown spacer. As a liquid crystal for filling the spacing, depending on an operation mode of the liquid crystal, a material having a negative or positive dielectric anisotropy is selected.

Typical liquid crystal alignment modes are shown in FIGS. 4(a) to 4(d).

FIG. 4(a) shows a complete homeotropic alignment mode in which a long axis of the liquid crystal molecules is oriented perpendicularly to the substrates.

FIG. 4(b) shows a homeotropic alignment mode with a pretilt angle in which a long axis of liquid crystal molecules is inclined from a direction of a normal to the substrate with a certain angle.

FIG. 4(c) shows a homogeneous alignment mode with a pretilt angle in which a long axis of liquid crystal molecules rises from a substrate surface with a certain angle.

FIG. 4(d) shows a complete homogeneous alignment mode in which liquid crystal molecules are completely horizontally aligned between the alignment films with respect to the substrate surfaces.

The pretilt angle can be measured by preparing an inclination angle measuring cell separately from the above-prepared liquid crystal cell (liquid crystal device) and then performing a known crystal rotation method.

### (Pretilt Angle of Oblique Deposition Film)

In a LCOS (liquid crystal on silicon) panel or the like for a microdevice, such a liquid crystal mode that liquid crystal molecules are vertically aligned when a voltage is not applied and a transmittance is increased with a degree of inclination of the liquid crystal molecules from the vertically aligned state under voltage application (referred to as a “VA (vertical alignment) mode”) is ordinarily used.

When a pixel spacing is decreased with a fine pixel structure, disclination occurs due to a lateral electric field between pixels to lower a contrast. In order to prevent the occurrence of the disclination, an increase in pretilt angle is effective. However, when the pretilt angle is increased, even under no electric field application, light passes through the panel to some extent, so that the contrast is also lowered in this case. In the LCOS panel, the pretilt angle is required to be controlled in a range of 1-15 deg.

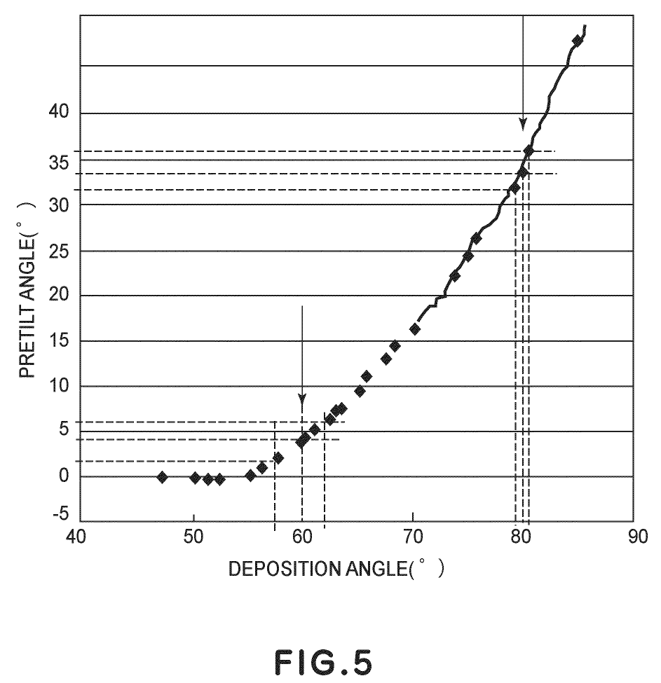

FIG. 5 shows a relationship between a deposition angle of an oblique deposition film and a pretilt angle of liquid crystal alignment. The pretilt angle is defined as an angle of liquid crystal alignment with respect to a normal to a substrate. A complete homeotropic (vertical) alignment provides a pretilt angle of 0 deg.

As shown in FIG. 5, in the relationship between the deposition angle of the oblique deposition film and the pretilt angle, the pretilt angle is deviated from 0 deg. at a deposition angle of 60 deg. or more. In order to obtain a non-zero small pretilt angle, e.g., 4 deg., the deposition angle is set to about 60 deg.

### (Pretilt Angle of Film Comprising Sputtering Film Laminated on Oblique Deposition Film)

When a pretilt angle of a film prepared by laminating a 20 nm-thick sputtering film of SiO₂ on a 80 nm-thick oblique deposition film of SiO₂ with a deposition angle of 80 deg. was measured, the pretilt angle was 15 deg. This value is smaller than a pretilt angle (about 33 deg.) of the oblique deposition film alone estimated from FIG. 5. From this fact, the lamination film of the sputtering film on the oblique deposition film provides a smaller pretilt angle than the oblique deposition film alone. That is, the sputtering film has the function of lowering the pretilt angle.

By laminating the SiO₂ film through the sputtering on the obliquely deposited SiO₂ film, it is possible to control the pretilt angle in a liquid crystal alignment mode such as the VA (vertical alignment) mode.

As is conventionally known, depending on the film forming condition of the oblique deposition, it is possible to form a film different in inclination angle and column thickness. By laminating the sputtering film on the oblique deposition film, the pretilt angle can be controlled.

In order to obtain a desired pretilt angle, the oblique deposition is performed at a deposition angle larger than a deposition angle read from FIG. 5 and then the sputtering film may be laminated on the oblique deposition film.

When the oblique deposition is performed at the large deposition angle, nonuniformity of the deposition angle in a plane of the substrate is advantageously decreased even before the sputtering film is laminated on the oblique deposition film.

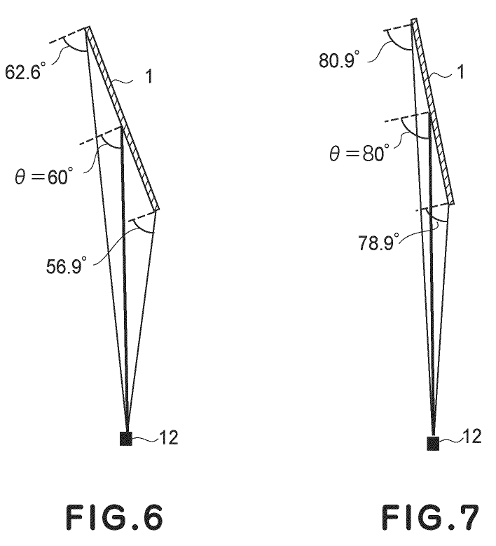

More specifically, FIG. 6 shows a distribution of a deposition angle in a plane of the substrate when the oblique deposition at a deposition angle of 60 deg. is performed. A broken line represents a normal to the substrate 1. The substrate 1 is an Si wafer having a diameter of 8 inches. A distance from a substrate center to a deposition source is 1 m.

As shown in FIG. 6, at a point closest to the deposition source, the deposition angle is 56.9 deg. and at a point furthermost from the deposition source, the deposition angle is 62.6 deg. Thus, the deposition angle distribution is −3.1 deg. for the closest point and +2.6 deg. for the furthermost point, respectively, with respected to the deposition angle at the substrate center.

The pretilt angles corresponding to this deposition angle distribution are estimated from FIG. 5. Three (vertical) broken lines in the neighborhood of the deposition angle of 60 deg. represent relationships of pretilt angles and a maximum deposition angle, a center deposition angle, and a minimum deposition angle, respectively. The pretilt angle is 2.0 deg. at the closest point to the deposition source and 6.5 deg. at the furthermost point from the deposition source. Thus, with respect to the pretilt angle of 4.0 deg. at the substrate center, the pretilt angle is distributed in a range from −2 deg. to +2.5 deg., thus providing a distribution width of 4.5 deg.

On the other hand, in the case of the oblique deposition at the deposition angle of 80 deg. at the substrate center, the deposition angle distribution in the substrate plane is as shown in FIG. 7. The deposition angle is 78.9 deg. at the closest point to the deposition source and 80.9 deg. at the furthermost point from the deposition source. Thus, the deposition angle distribution ranges from −1.1 deg. to +0.9 deg. with respect to the deposition angle of 80 deg. at the substrate center. This deposition angle distribution range (width) is narrower than that in the case of the above-described deposition angle of 60 deg. As a result, corresponding pretilt angles are, as indicated by three (horizontal) broken lines in the neighborhood of a point of the deposition angle of 80 deg. in FIG. 5, 33.5 deg. at the substrate center, 32.0 deg. (minimum), and 36 deg. (maximum). Thus, the pretilt angle distribution ranges from −1.5 deg. to +2.5 deg. with respect to the center pretilt angle, i.e., is within 4.0 deg. as a distribution width.

As described above, when the deposition is performed at the large deposition angle, the resultant distribution width falls within a small range with respect to both of the deposition angle and the pretilt angle. Accordingly, in order to obtain the same pretilt angle, it is advantageous to perform the oblique deposition at the large deposition angle. The method for laminating the sputtering film on the oblique deposition film according to the present invention is found to have the advantages of a decreased nonuniformity in deposition angle in addition to a reduction in film forming time.

### (Shape of Lamination Film)

The reason why the pretilt angle is decreased by the lamination of the sputtering film has not been clarified at present.

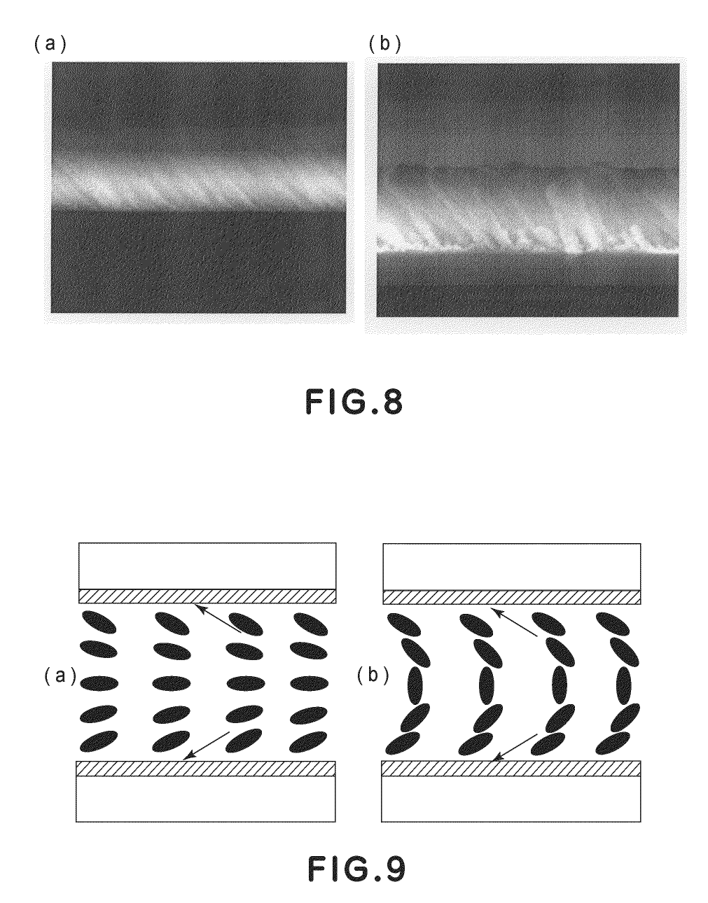

FIGS. 8(a) and 8(b) are cross-sectional SEM images (25.0 V, magnification: 30,000) of an oblique deposition film (deposition angle: 80 deg.) of SiO₂ (FIG. 8(a)) and an SiO₂ lamination film obtained by laminating a 20 nm-thick sputtering film of SiO₂ on the oblique deposition film (FIG. 2(b)). From these figures, even when the sputtering film is laminated, a column angle of a column structure is not largely changed, so that it is found that the sputtering SiO₂ film also grows in a direction of an oblique extension of the columns. Further, a width (thickness) of the columns is increased. That is, the lamination film is not changed largely in column (inclination) angle but is increased in column thickness and filling ratio.

Next, the present invention will be described based on Examples. In the following Examples, films may be formed by using the film forming apparatus shown in FIG. 2 and by a combination of an oblique deposition apparatus and a sputtering apparatus.

### EXAMPLE 1

As a substrate 1, a glass substrate provided with a patterned electrode film was prepared.

On the surface of the substrate 1, an alignment film 2 of silicon oxide was formed by oblique deposition. As a deposition source, SiO₂ powder was used and vaporized by electron beam heating.

The substrate 1 was not particularly heated and subjected to the oblique deposition at a film forming speed of 0.1 nm/sec and a film forming time of 100 sec., so that the resultant alignment film 2 had a thickness of 10 nm.

Next, from above the alignment film 2, an alignment film 3 of silicon oxide was formed by sputtering. As a sputtering target, SiO₂ sintered compact was used and the sputtering was performed in an Ar atmosphere. The film formation was completed at the time when the entire thickness of the alignment films reached a predetermined value of 50 nm in this case, so that formation of an entire alignment film 4 was completed.

During the sputtering film formation, a film forming speed was 0.6 nm/sec. In order to provide a total film thickness of 50 nm, a sputtering time was set to 67 sec. so as to form a 40 nm-thick sputtering film as a target. A total film forming time was 167 sec.

After the completion of the film formation, the substrate was taken out of the film forming apparatus and subjected to FE-SEM observation at room-section thereof. The entire alignment film has an oblique groove structure or an oblique column structure, thus assuming a feature of the oblique deposition film. Next, a cell in which a liquid crystal was injected was prepared by using this substrate and subjected to evaluation of a liquid crystal alignment characteristic, so that a good characteristic was obtained.

### COMPARATIVE EXAMPLE 1

An alignment film was formed in the same manner as in Example 1 except that the entire alignment film was formed by using only the oblique deposition. The film forming speed is the same (0.1 nm/sec) as in Example 1 and the oblique deposition was performed for 500 sec. to provide a film thickness of 50 nm. When the resultant alignment film was subjected to evaluation of the liquid crystal alignment characteristic, the same result as in Example 1 was obtained. However, a total film forming time was 3 times or more that in Example 1.

### EXAMPLE 2

An alignment film was formed in the same manner as in Example 1 except that SiO power was used as the deposit source for the oblique deposition and was vaporized by resistance heating to be formed in a film. A shape of a cross-section of the alignment film and a liquid crystal alignment characteristic were the same as those in Example 1.

### COMPARATIVE EXAMPLE 2

An alignment film was formed in the same manner as in Example 2 except that the entire alignment film was formed by using only the oblique deposition. Evaluation results (shape observation and measurement of liquid crystal alignment) were the same as those in Example 2. However, the film forming time was about 2 times that in Example 2.

### EXAMPLE 3

It is possible to prepare a liquid crystal device with bend alignment by using an SiO₂ alignment film obtained by laminating a sputtering film on an oblique deposition film. By controlling a pretilt angle at about 45 deg. so as to align liquid crystal molecules in a bend alignment state, it is possible to prepare an OCB mode liquid crystal apparatus with a high contrast and a high response speed.

On a substrate prepared by forming a 20 nm-thick ITO film on a glass base material, an SiO₂ film was formed in a thickness of 60 nm by oblique deposition while inclining the substrate so as to provide a deposition angle of 85 deg. at the substrate center.

On the oblique deposition film, a 20 nm-thick SiO₂ film is laminated by RF sputtering under a sputtering condition including Ar: 10 sccm, Oxygen gas: 1.0 sccm, pressure: 1×10³ Torr, RF electric power: 400 W, substrate temperature: room temperature, substrate: ground, and sputtering time: 3 min.

The resultant substrate was divided into plural portions, of which two divided substrates were, as shown in FIG. 3, applied to each other so that deposition directions (705 and 706 indicated by arrows in FIG. 3) are parallel to each other to prepare a cell. In this case, on an outer peripheral surface of one of the substrates, a sealing agent comprising an ultraviolet curable resin material containing silica or resin beads (diameter: 3 μm) was applied so as to provide a cell gap of 3 μm.

After the application, ultraviolet irradiation and heat curing were performed and thereafter a liquid crystal material having a positive dielectric anisotropy was injected into the cell in a vacuum liquid crystal injection apparatus. Onto an injection port, a sealing material was applied and the liquid crystal material was sealed within the cell. The thus prepared liquid crystal cell was kept at 100° C. for 5 minutes and gradually cooled to 50° C. so as to re-align the liquid crystal molecules.

Two polarizers were arranged in a cross-nicol state and the liquid crystal cell was interposed therebetween. The liquid crystal cell was illuminated with light from the lower polarizer side to observe an alignment state of the liquid crystal molecules in the liquid crystal cell. In a state in which a voltage was not applied to the liquid crystal cell, the liquid crystal cell was observed to assume yellow. This state is a splay state shown in FIG. 9(a).

Next, a rectangular wave voltage of 60 Hz was applied between the upper and lower ITO electrodes to change a peak value of the voltage. By gradually increasing the voltage, the state of the liquid crystal cell was changed to a gray state at a voltage of 3.5 V or more. This means that the alignment state of the liquid crystal molecules in the liquid crystal cell was changed from the splay state (mode) shown in FIG. 9(a) to a bend state (mode) shown in FIG. 9(b).

The gray state means that a retardation of the liquid crystal cell is larger than that of a liquid crystal cell in Comparative Example 3 described later. When the applied voltage was returned to 0 V, the alignment state was returned to the splay alignment state but a transition speed thereof was slow, so that the liquid crystal cell was suggested to be placed in a state of readily inducing the bend alignment state.

In this embodiment, separately from the preparation of the liquid crystal cell, a cell for measuring a pretilt angle was prepared and the pretilt angle was measured by a known crystal rotation method.

The liquid crystal cell of this example is characterized by a large column width and high filling ratio of the alignment film, so that a porosity of the alignment film was improved. As a result, it is possible to expect that durability of the liquid crystal alignment is improved. Such a change in alignment film structure enables control of the liquid crystal alignment, especially control of the pretilt angle.

By laminating the sputtering film on the oblique deposition film, the thickness, the column width, and the filling ratio of the alignment film are changed, so that it is possible to effectively control the pretilt angle.

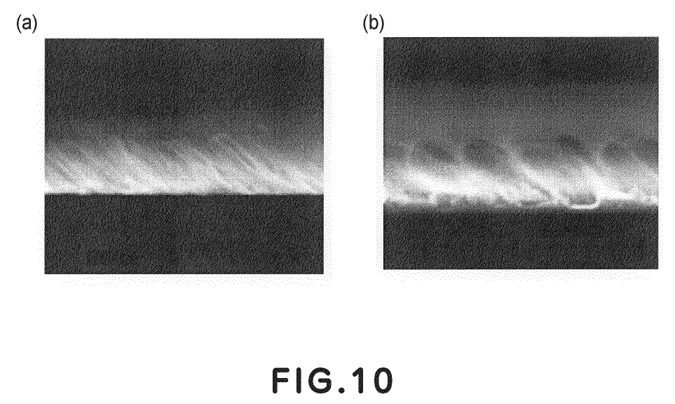

FIGS. 10(a) and 10(b) are cross-section SEM images (25.0 V, magnification: 30,000) of an SiO₂ oblique deposition film (60 nm) formed at a deposition angle of 87.5 deg. by the oblique deposition (FIG. 10(a)) and an SiO₂ sputtering film (20 nm) formed and laminated on the oblique deposition film through the sputtering (FIG. 10(b)). When the 20 nm-thick SiO₂ sputtering film was laminated on the oblique deposition film, it was observed that the columns further grew in an inclination direction and a width (thickness) of the columns was increased.

The liquid crystal device of this example is capable of inducing the bend alignment at a low voltage and has a large retardation. Further, the liquid crystal device has such a feature that the column is thick and the filling ratio is large, thus being useful for stabilization of the pretilt angle and improvement in durability performance.

### COMPARATIVE EXAMPLE 3

An liquid crystal cell (panel) for observation of a bend alignment state (mode) was prepared in the same manner as in Example 3 except that the 20 nm-thick SiO₂ sputtering film was not laminated on the oblique deposition film. When the liquid crystal cell was observed in the same manner as in Example 3, the liquid crystal cell of this Comparative Example 3 assumed black gray state even under no voltage application to the ITO electrodes. This means that the alignment state of the liquid crystal molecules in the liquid crystal cell is the bend alignment state (mode) through no splay alignment state (mode).

However, compared with gray of the liquid crystal cell of Example 3, the color of the liquid crystal cell of this comparative example was close to black, so that it was found that a retardation was not sufficiently ensured. This liquid crystal cell placed in such a state was left standing for several days but was not placed in the splay alignment state, so that it was found that the liquid crystal cell was placed in a state of easily inducing the bend alignment state.

Further, a cell for measuring the pretilt angle was prepared in the same manner as in Example 3 except that the 20 nm-thick SiO₂ sputtering film was not laminated on the oblique deposition film. As a result of measurement of the pretilt angle, the liquid crystal cell of this comparative example had a pretilt angle of 48.1 deg. (as an inclination angle on a horizontal direction basis), so that it was found that the pretilt angle was larger than a pretilt angle of 42.4 deg. (as an inclination angle on the horizontal direction basis) of the liquid crystal cell of Example 3. As a result, it was found that when the pretilt angle was large, the retardation was small although the liquid crystal alignment state was changed to the bend alignment state under no voltage application.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 028040/2007 filed Feb. 7, 2007 and 021010/2008 filed Jan. 31, 2008 which is hereby incorporated by reference.

What is claimed is:

1. A method for forming an alignment film of a liquid crystal, comprising:
a step of forming a first film on a substrate by an oblique deposition method; and
a step of forming a second film on the first film by a sputtering method.

2. A method according to claim 1, wherein the oblique deposition method comprises steps of evaporating a material by heating a source of the material and depositing the evaporated material obliquely onto the substrate.

3. A method according to claim 1, wherein the second film is formed at a room temperature.

4. A method according to claim 1, wherein the second film is formed by an oblique sputtering method.

5. A method according to claim 1, wherein the second film is formed in a rare gas atmosphere.

6. A method according to claim 1, wherein the rare gas atmosphere comprises Ar.

7. A film forming apparatus for forming an alignment film of a liquid crystal, comprising:
first means for evaporating a first material by heating a source of the first material;
second means for evaporating a second material by sputtering a target of the second material; and
a stage for mounting a substrate to obliquely deposit the first material evaporated by the first means and to deposit the second material evaporated by the second means onto the first material.

8. An alignment film of a liquid crystal comprising:
a first film formed on a substrate by an oblique deposition method; and
a second film formed on said first film by a sputtering method.

9. A liquid crystal device comprising:
a pair of substrates;
an alignment film formed on an inner surface of each of said pair of substrates; and
a liquid crystal disposed between said pair of substrates,
wherein said alignment film comprises a first film formed by an oblique deposition method and a second film formed on the first film by a sputtering method.
